(19) United States
(12) Patent Application Publication
(10) Pub. No.: US 2004/0081053 A1
(43) Pub. Date: Apr. 29, 2004

(54) Event timing adjustment method and device

(76) Inventor: Hiroaki Kojima, (US)

Correspondence Address: TEXAS INSTRUMENTS INCORPORATED, P O BOX 655474, M/S 3999, DALLAS, TX, 75265

(21) Appl. No.: 10/687,722

(22) Filed: Oct. 17, 2003

(30) Foreign Application Priority Data
Oct. 18, 2002 (JP) 2002-303,964

(51) Int. Cl. G11B 7/0045

(52) U.S. Cl. 369/59.11

(57) ABSTRACT

An event timing adjustment device that can realize timing adjustment of any event in a simpler and more correct way. The event timing adjustment circuit has multiphase clock generating portion 5 that generates multiphase clocks, and multiphase clock use portion 3. The multiphase clock generating portion 5 generates plural phase clocks having different phases applied for an event input received by input terminal 1. The plural pulse clocks represent plural different adjustment quantities, respectively. Multiphase clock use portion 3 uses any one phase clock among the multiphase clocks, and it generates an event change timing signal representing the changed timing of said event.

### FIELD OF THE INVENTION

This invention pertains to a method and device for the adjustment of timing of various events, such as electrical events.

### BACKGROUND OF THE INVENTION

In the prior art, a method using elements with a fixed delay quantity is adopted as the method for adjusting the timing of electrical events, such as the timing of generation of transitions in signals. That is, by using a combination of plural elements with a fixed delay quantity, the desired delay quantity for adjustment of timing can be generated. As far as the delay elements are concerned, various conventional elements may be used, such as buffer chains, delay lines, etc.

Said timing adjustment is needed in various fields. Especially, examples of fields where a high-grade timing adjustment is required include the field of pulse width adjustment of write pulses in recorders for CD, DVD, and other optical disk recording media, and the field of synchronization of digital transmission data in data transmission.

For example, for CD-R, CD-RW, DVD-R, DVD-RW, DVD+R, DVD+RW, DVD-RAM devices, etc. (hereinafter to be referred to as optical disk recorders), in order to obtain a unified shape for the bits written on the disk, it is necessary to finely adjust the output of the laser used in write on the disk. Usually, said fine adjustment is carried out by performing pulse control to turn the laser output ON/OFF.

In the prior art, for said timing adjustment or fine adjustment of the laser output power in optical disk recording, the pulse delay quantity is controlled by means of said plural fixed delay elements in the recorder. Also, in order to reduce the delay element number (size) while ensuring the delay control quantity in a wide range, two types of delay elements are prepared, that is, plural delay elements that allow change in the delay quantity in relatively long units, and plural delay elements that allow change in the delay quantity in relatively short units Japanese Kokai Patent Application No. 2001-209958. However, in this method of the prior art, since the structure uses plural delay elements, due to variation in the manufacturing process, differences in the absolute quantity of delay take place among individual delay elements. Also, due to the circuit constitution for realizing the delay elements, the absolute delay quantity is prone to influence by variation in the ambient temperature and power source voltage. Also, for adjustment of the write pulses, plural delay units, each of which contains plural delay elements, are needed. Since the delay units are relatively large, the absolute delay quantities at different positions of setting on the integrated circuit (IC) are different from each other. Consequently, it is difficult to realize delay at the tap position (tap delay) designed such that the same delay quantity is generated for all of the delay units. In addition, in the constitution, even when the tap with the smallest delay quantity (zero delay) is selected, because a significant quantity of fixed delay (overhead) is generated, it is necessary to prepare a delay element row for canceling said overhead separately. Also, it is necessary to execute matching so that the delay quantity is the same as the zero delay. However, in actual operation, it is hard to execute correct matching. Even when matching is executed, errors still can take place due to variation in the manufacturing process and other factors.

In addition, since the delay quantity is fixed for each delay element, when the write speed multiple on the optical disk is changed, the delay adjustment quantity for the write pulses has to be changed significantly too. Also, for the same reason, in the case of write at a high speed multiple, the relative adjustment resolution decreases. On the other hand, in order to support write at a low speed multiple, a longer delay is needed, and more delay elements should be prepared. For current sub-micron processing, the delay quantity for each element is becoming smaller and smaller. However, for the conventional constitution, in order to realize the same delay quantity, the number of delay elements has to be increased. As a result, the circuit area inevitably becomes larger.

Also, as the speed multiple increases, the width of the write pulses decreases. On the other hand, due to the constitution of the delay elements, there is a minute difference between the rise delay and fall delay of pulses. As plural delay elements are connected in series, the delay differences add up, and pulses disappear as they pass through the delay units. This is a problem. In addition, when the disk is rotated at a CAV (Constant Angular Velocity) that allows easy rotation control, it is necessary to gradually change the delay adjustment quantity corresponding to the gradual change in the write speed multiple due to differences in the circumference for the write position on the disk plane. In the conventional method, it is only possible to execute stepwise correction and change for the delay quantity corresponding to the write position, and a complicated control must be carried out. This is undesirable.

As another prior art, there is a method in which characteristics of oscillation delay (delay of light emission from application of current) of a semiconductor laser are exploited in the semiconductor laser driving method and the optical disk device using said method Japanese Kokai Patent Application No. 2002-123963. In this method, by means of the magnitude of the current immediately before application of the power needed for write (base current), it is possible to control the delay of laser oscillation from application of the write current. By controlling the base current value corresponding to variation in the write speed, CAV write can be realized. Also, there is a method in which the time precision of the write pulses is maintained in the recording device Japanese Kokai Patent Application No. 2002-50045. In this method, by using an element that generates a DUTY (delay) corresponding to the detected error quantity, a feedback loop is formed to ensure the timing precision.

Also, in another proposed method Japanese Kokai Patent Application No. Hei 8[1996]-87834, in an optical pulse width controller for an optical disk, by using a delay element with a variable delay quantity under a control signal, the delay quantity is corrected on a regular basis to ensure the precision of the pulse width.

In addition, in another method Japanese Kokai Patent Application No. 2000-76684, when CLV write is performed for an optical disk under CAV rotation control, the laser power is controlled in an optimized state. In this case, the laser power is controlled corresponding to the wobble frequency. However, no description is provided for the method for controlling the laser control pulse width. When a method is embodied for products, it is necessary to control both the power and the pulse width.

A general object of this invention is to provide an event timing adjustment method and device comprising a timing adjustment that can be realized for any event in a simple and correct way.

### SUMMARY OF THE INVENTION

This and other objects and features are provided, in accordance with one aspect of this invention by a timing adjustment method for adjusting the timing of an event comprising a timing adjustment of the event carried out based on multiphase clocks.

According to another aspect of this invention, said event may be an electrical event. Also, said electrical event may be at least one transition between plural electrical states. In addition, said transition between electrical states may be the rise or fall of prescribed pulses. In this case, said multiphase clocks can be generated from a reference signal pertaining to said prescribed pulses. In this case, one selection from said multiphase clocks can be used in forming the rise or fall in said prescribed pulses.

Also, according to a third aspect of this invention, said transition between electrical states may be a transition in digital transmission data. In this case, said multiphase clocks can be generated from the transmission clock of said digital transmission data. Similarly, one selection from said multiphase clocks can be used in forming a transition after timing adjustment in said digital transmission data.

In addition, according to a fourth aspect of this invention a timing adjustment method comprising an adjusting a timing of an event, generating a multiphase clock for generating multiphase clocks, with said multiphase clocks composed of plural phase clocks of different phases that represent plural different timing adjustment quantities applied on said event, and using a multiphase clock in which any one phase clock from said multiphase clocks is used, and an event change timing signal representing the changed timing of said event is generated.

Also, according to a fifth aspect of this invention a timing adjustment method for adjusting timing of one event group composed of plural events comprises decomposing the event group into individual events, and a step in which the timing adjustment method described above is embodied for each of said decomposed events.

Also, according to a sixth aspect of this invention provides a timing adjustment method which also has an event timing signal representing said timing of event is generated. The event timing signal is in synchronization with said multiphase clocks. In this case, said multiphase clock generating step also contains a step in which said multiphase clocks are generated in synchronization with a reference signal related to said event.

Also, according to a seventh aspect of this invention, said multiphase clock can be composed of plural phase clocks with equal spacing between them. Also, said phase clock may have a clock portion representing the corresponding timing adjustment quantity.

Also, according to an eighth aspect of this invention, said events may be events on an optical disk recording medium. The events on said optical disk recording medium may be rise events and fall events of write pulses in the pulse width adjustment of the write pulses for writing on said optical disk recording medium; said write pulses may be for determining the timing of control of output of the laser used in write on said optical disk recording medium. In this case, in said event timing signal generation, said event timing signal can be generated from said write pulses. Also, there may also be generation of write pulses after timing change are generated from said event change timing signal.

According to a ninth aspect of this invention, said multiphase clock generation may also obtain said reference signal related to said events is obtained from the wobble signal of said optical disk recording medium. Also, said optical disk recording medium may have a rotation control system, such as a CAV system, zone CLV system, or CLV system.

According to a tenth aspect of this invention, said events may be events in digital transmission data. In this case, said multiphase clocks may be generated from the transmission clock of said digital transmission data.

Also, according to an eleventh aspect of this invention, said multiphase clock use also has an adjustment quantity input that assigns the timing adjustment quantity applied on said events is received, and a selection of said phase clock having said timing adjustment quantity corresponding to said adjustment quantity input is selected as said event change timing signal. In this case, said use may also have said event change timing signal applied on said events.

In addition, according to a twelfth aspect of this invention provides a timing adjustment circuit comprising a timing adjustment circuit for adjusting timing of events comprises the following means: a multiphase clock generating means for generating multiphase clocks, with said multiphase clocks composed of plural phase clocks having different phases representing plural different adjustment quantities applied on said events, and a multiphase clock use means that uses any one said phase clock selected from said multiphase clocks and generates an event change timing signal representing the changed timing of said events.

According to a thirteenth aspect of this invention, the timing adjustment circuit for an event group adjusts the timing of one event group composed of plural events, and it comprises of the following means: an event decomposition means that decomposes said event group into individual events, and an event group timing adjustment means composed of timing adjustment circuits for said various events, respectively. Also, according to this invention, the timing adjustment circuit may contain a synthesis means that receives said event change timing signals generated by said timing adjustment circuit for said events in said event group and synthesizes them to generate a synthetic event change timing signal. Also, said timing adjustment circuits set for said events, respectively, can contain a common multiphase clock generating means.

According to a fourteenth aspect of this invention, the timing adjustment circuit may also contain a means for generating an event timing signal that represents the timing of said events, with said event timing signal in synchronization with said multiphase clocks. In this case, said multiphase clock use means may contain an enlarging means that receives said event timing signal and, by delaying the event timing signal, enlarges said timing adjustment quantity by means of said multiphase clocks alone.

Also, according to a fifteenth aspect of this invention, said multiphase clock generating means may contain a PLL circuit means that generates said multiphase clocks in synchronization with a reference signal pertaining to said events.

Also, according to a sixteenth aspect of this invention, said multiphase clock use means may contain the following means: a means for receiving an adjustment quantity input that assigns the timing adjustment quantity applied on said events, and a selection means that selects one said phase clock having said timing adjustment quantity corresponding to said adjustment quantity input as said event change timing signal from said multiphase clocks. Also, said multiphase clock use means may also contain an application means for applying said event change timing signal on said events.

In addition, according to a seventeenth aspect of this invention, the pulse width adjustment device for use in an optical disk recorder of this invention is characterized by the fact that the pulse width adjusting device has said timing adjustment circuit.

Also, according to an eighteenth aspect of this invention, the optical disk recorder has said pulse width adjustment device.

### BRIEF DESCRIPTION OF THE DRAWINGS

FIG. 1 is a block diagram illustrating the basic constitution of the timing adjustment circuit in this invention.

FIG. 2 is a block diagram illustrating pulse width controller A for an optical disk recorder in an embodiment of the timing adjustment circuit shown in FIG. 1.

FIG. 3 is a timing diagram illustrating various types of pulses in pulse width controller A shown in FIG. 2.

FIG. 4 is a block diagram illustrating a delay tapping circuit 30A-k in pulse width controller A shown in FIG. 2.

FIG. 5 is a timing diagram illustrating 16-phase clocks, that is, phase 00-phase 15, as an example of multiphase clocks generated by the multiphase clock generator shown in FIG. 2.

FIG. 6 is a circuit diagram illustrating in detail the decoder and selecting circuit shown in FIG. 4.

FIG. 7 is a timing diagram illustrating the overall operation of pulse width controller A having the delay tapping circuit shown in FIG. 4.

FIG. 8 is a timing diagram illustrating the state in which a constant relative delay is obtained at all times by using a multiphase clock in this invention.

FIG. 9 is a block diagram illustrating the circuit constitution of an embodiment of the multiphase clock PLL shown in FIG. 2.

FIG. 10 is a block diagram illustrating an embodiment of optical disk recorder B using the pulse width controller of this invention.

FIG. 11 is a timing diagram illustrating an example of the output waveforms of pulse generator circuits 24-28 shown in FIG. 10.

FIG. 12 is a block diagram illustrating delay tapping circuit 30C in another embodiment.

FIG. 13 is a block diagram illustrating delay tapping circuit 30D in yet another embodiment.

FIG. 14 is a block diagram illustrating synchronization device M for digital transmission data as another embodiment for timing adjustment of this invention.

FIG. 15 is a timing diagram illustrating the overall operation of synchronization device M shown in FIG. 14 as compared with the case when a gate delay is used.

FIG. 16 is a block diagram illustrating in detail an embodiment of multiphase synchronization circuit 3M shown in FIG. 14.

FIG. 17 is a timing diagram illustrating the overall operation of multiphase synchronization circuit 3M shown in FIG. 16.

### REFERENCE NUMERALS AND SYMBOLS AS SHOWN IN THE DRAWINGS

In the figures, 1, 1A, 1M represent input terminals; 2A, 2B pulse generators;

3, 3A multiphase clock use portions; 3M a multiphase synchronization circuit; 5, 5A multiphase clock generators; 5M a multiphase clock PLL circuit; 7, 7A, 7M output terminals; 8B a laser controller; 9B a laser for write; 24-28 pulse generator circuits; 30A a delay tapping circuit; 32A, 32B pulse synthesizers; 301A, 301C, 301D input registers; 303D a delay setting range extension portion; 304A, 304C, 304D timing adjusting registers; 306A, 306C, 306D, 306M high-order register groups; 308A, 308C, 308D, 308M low-order register groups; 310A, 310C, 310D, 310M decoders; 312A, 312C, 312D, 312Ma, 312Mb selecting circuits; 315M an output register; 316M a selecting register; 520 a phase comparator; 522 a frequency divider; 524 a loop filter; 526 a ring oscillator portion.

### DESCRIPTION OF THE EMBODIMENT

In the following, this invention will be explained in more detail with reference to embodiments illustrated by figures.

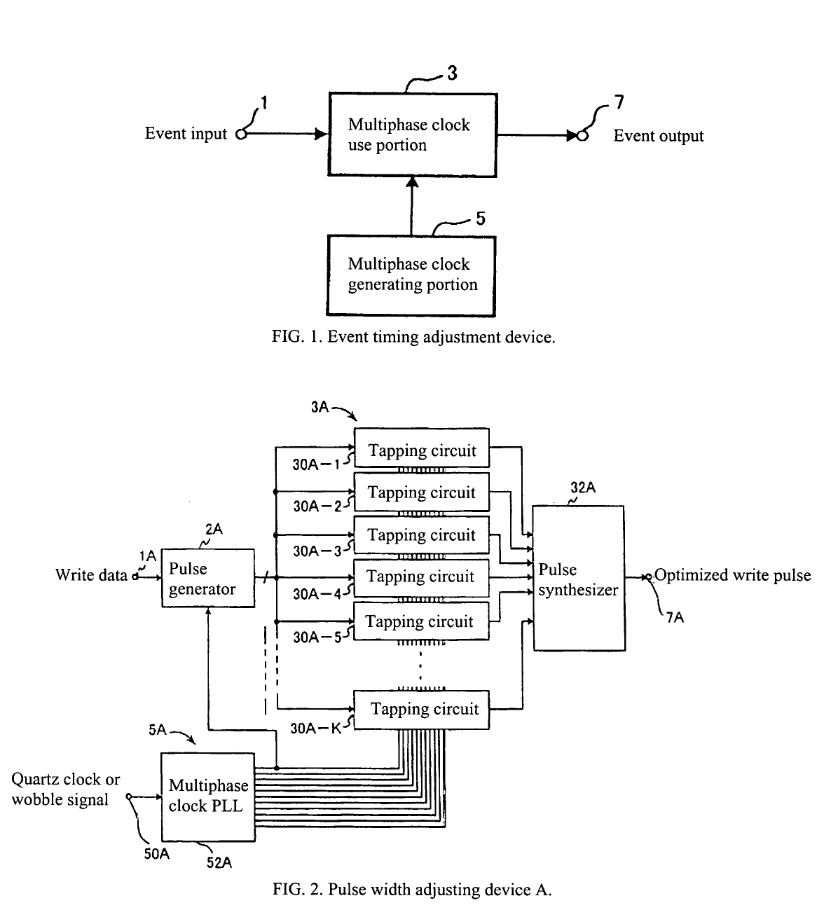

FIG. 1 is a diagram illustrating the basic constitution of the timing adjustment device in this invention. As shown in the figure, this timing adjustment device has input terminal 1 for receiving an event input. Also, it has multiphase clock use portion 3 that receives the event input received by said terminal, and multiphase clock generating portion 5 that feeds a generated multiphase clock to use portion 3. For multiphase clock use portion 3, by using the received multiphase clock with respect to the received event input, timing of the event input is adjusted, and the event after adjustment is generated at output terminal 7.

For the timing adjustment device of this invention, by using any phase clock among the plural phase clocks of the multiphase clock, it is possible to impart a delay quantity (each unit of the delay quantity is an inter-phase delay) corresponding to the pulse delay (inter-phase delay) of the selected phase clock, and there is no need to use delay elements having a fixed delay quantity as would be needed in the prior art. By using the multiphase clocks, the device becomes less amenable to influences of variation parameters, such as manufacturing process, ambient temperature, power source voltage, etc. As a result, it is possible to realize more correct timing adjustment with a simpler circuit constitution. Also, by increasing the frequency of the multiphase clocks, one can easily improve the resolution of timing adjustment. Also, improvement of the timing adjustment resolution can be realized by increasing the number of phase clocks contained in the multiphase clocks, that is by increasing the phase number. In addition, by prolonging the period of the multiphase clocks, or by moving the application position of the multiphase clocks in units of 1 period of the multiphase clock, one can enlarge the timing adjustment range.

In the following, with reference to FIG. 2, an explanation will be provided for pulse width controller A for an optical disk recorder as an embodiment that specifies the timing adjustment device shown in FIG. 1. Here, the optical disk in this specification refers to a CD, DVD, and other optical disks, and the optical disk recorder refers to CD-R, CD-RW, DVD-R, DVD-RW, DVD+R, DVD+RW, DVD-RAM devices, etc. Also, as the rotation control system for the optical disk recorder, one may adopt any of CLV (Constant Line Velocity), zone CLV, and CAV (Constant Angular Velocity). However, in this invention, the CAV system can display the best effect. In addition, it is well known that for a recording type optical disk, from the tracks with data recorded on them, one can obtain a wobble signal that represents the linear velocity of the tracks. Corresponding to the various elements of the device shown in FIG. 1, said pulse width controller A has input terminal 1A for receiving write data to the optical disk, delay unit 3A composed of plural (k) delay units (or delay tapping circuits) 30A-l-k, multiphase clock generator 5A, and output terminal 7A. In addition, this device A also has pulse generator 2A and pulse synthesizer 32A as shown in the figure.

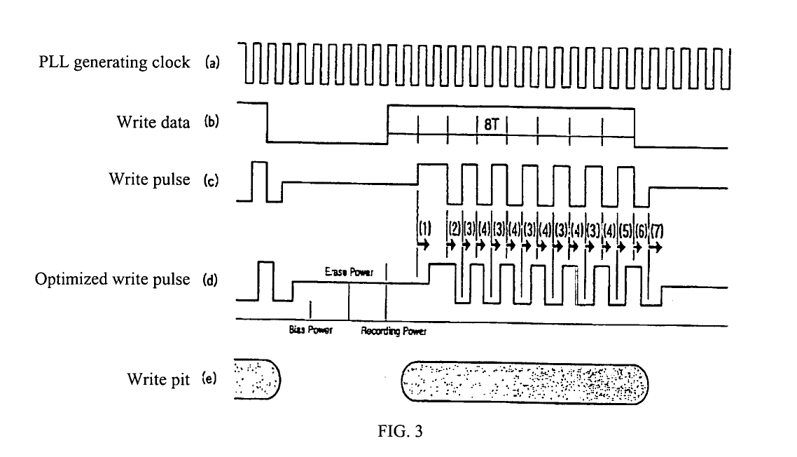

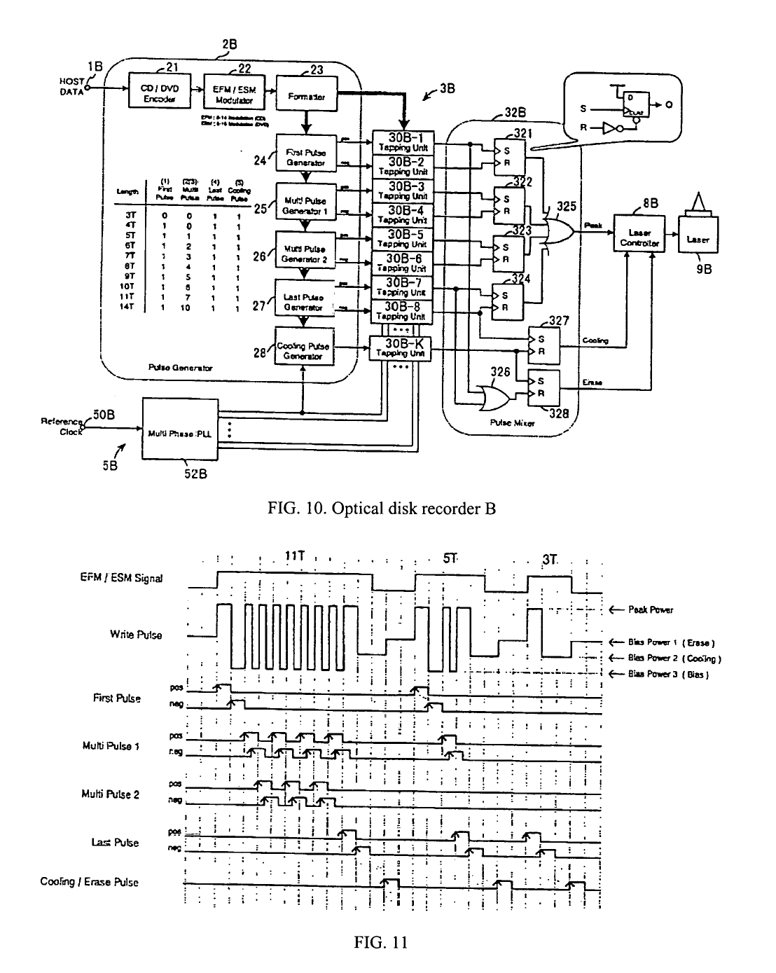

More specifically, pulse generator 2A is a circuit that can be formed by any logic circuit for generating write pulses corresponding to the bit signal sequence to be written. For one input, as shown in FIG. 3, write data are received from input terminal 1A (FIG. 3(b) illustrates an example of write data of “8T”), and, as another input, one phase clock among the multiphase clocks generated by multiphase clock generator 5A is received, and as shown in FIG. 3, write pulses are generated from the write data using a prescribed method. Various methods may be adopted for conversion from write data to write pulses. Pulse generator 2A decomposes said generated write pulses to pulses or a pulse sequence by means of a prescribed decomposition method. In the following, explanation will be provided for an example of decomposition of the write data of “8T” shown in FIG. 3. The write pulses shown in FIG. 3(c) can be understood as made of a group of plural events. With decomposition into individual events, decomposition into the following seven types occurs: rise portion 1 of the first pulse, fall portion 2 of the first pulse, rise portions 3 and fall portions 4 of the five intermediate pulses following said first pulse, rise portion 5 and fall portion 6 of the last pulse after said intermediate pulses, and, finally, end edge 7 of the last cooling pulse. However, this decomposition method is merely an example. One may also adopt other methods for decomposition. Consequently, the method depends on the bit length and its decomposition system. Said decomposed pulse portion supplies one [pulse to each of] delay tapping circuits 30A-l-k. Also, for said pulse generator, the pattern of the output waveform is standardized, and it can be constituted by any logic circuit. As an embodiment, an explanation will be provided with reference to FIG. 10. Also, FIG. 2 is a schematic diagram illustrating connection between pulse generator 2A and delay tapping circuits 30A-1-k. In addition, since pulse generator 2A works in synchronization with any one phase clock (shown in FIG. 3(a)) selected from multiphase clock generator 5A, as to be explained later, the rise and falling edges of the write pulse are in agreement with the phase clock (see FIGS. 3(a) and (c)).

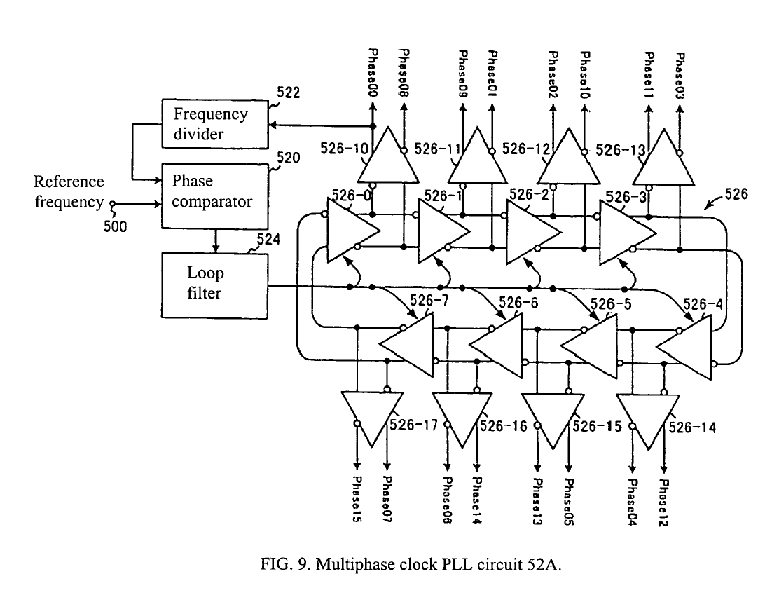

On the other hand, as shown in the figure, multiphase clock generator 5A has input terminal 50A for receiving a fixed frequency signal generated by a quartz clock oscillator or the like, said wobble signal recorded on a CD, or another reference signal, and multiphase clock PLL 52A having an input for receiving said reference signal. Multiphase clock PLL 52A may have various constitutions. As an example, the constitution shown in FIG. 9 can be described below. By means of synchronization with a reference signal, this multiphase clock PLL 52A generates multiphase clocks at a frequency M/N-fold its frequency. For example, by using the wobble signal from a CD as the reference, the multiphase clock PLL can generate clocks at a frequency corresponding to a speed multiple of write of the CD. Also, when multiphase clocks, such as 16-phase clocks, are generated, the operation can be realized easily. When the write speed is low, it can be realized by means of high-speed oscillation of a single-phase voltage control oscillator (VCO) in the PLL at a frequency 16-fold the PLL clock and dividing the frequency. On the other hand, when the write speed is high, it can be realized by adopting an 8-stage differential ring oscillator structure for the VCO, and fetching a clock from each of the differential buffers. The number of phases of the multiphase clocks generated by said multiphase clock PLL 52A depends on the resolution of the tap delay to be realized. For example, when a tap delay with a 16-fold resolution with respect to the PLL clock period is to be realized, phase clocks of 16 phases are needed. The multiphase clocks generated by multiphase clock PLL 52A are fed to delay tapping circuits 30A-l-k for all of the phases. Also, as shown in FIG. 2, one of these phases (usually phase 00) is also fed to pulse generator 2A so that write pulses with phase in agreement with the edge of said one phase of the clock are generated. In this case, if the constitution allows selection of a specific phase clock for use to generate the write pulses, it is possible to perform an adjustment of the input timing in the input register to be explained later. Also, FIG. 5 is a diagram illustrating an example of a 16-phase multiphase clock.

As shown in FIG. 5, the multiphase clock is composed of 16 phase clocks, that is, 00 phase-15 phase (Phases 00-15) clocks. These phase clocks are sequentially offset from each other by an equal quantity θ, that is, 1/16 the phase of the PLL clock. Here, the number “16” is in agreement with the tap delay resolution, that is, the relative delay resolution for 1 period of the PLL clock.

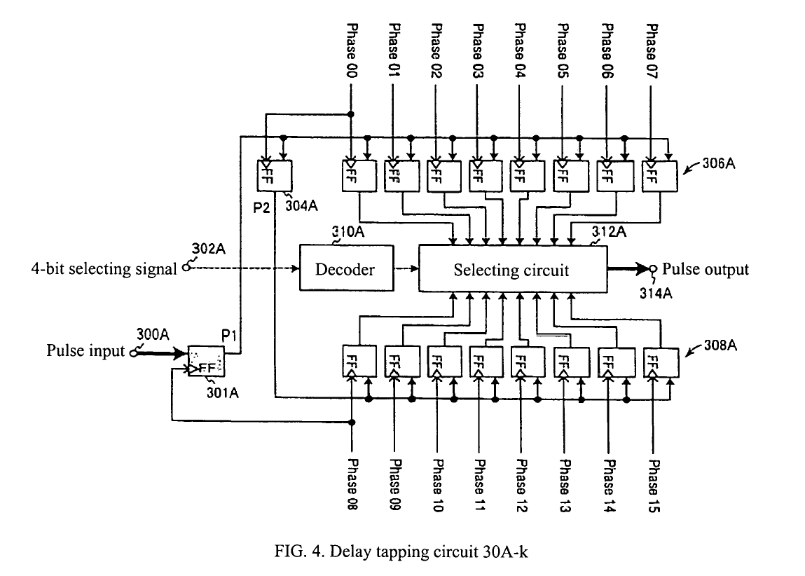

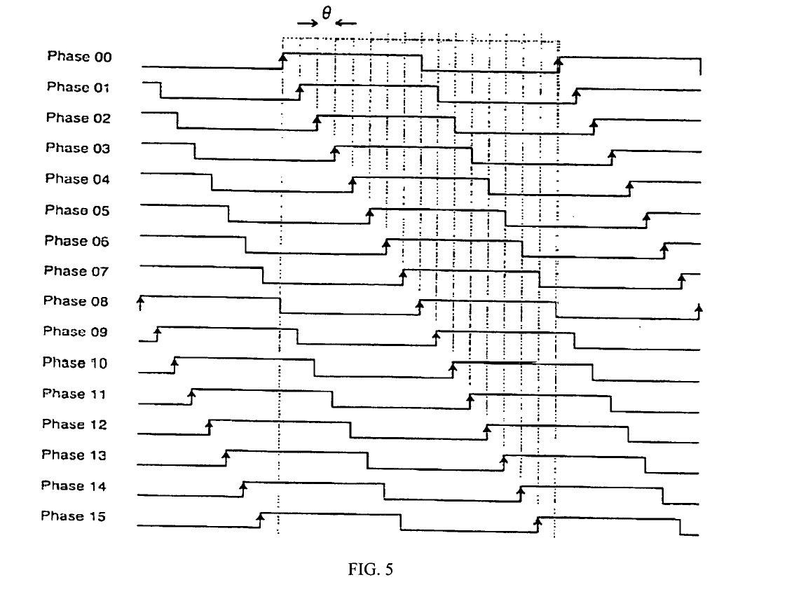

Then, each of the k delay tapping circuits 30-A-l-k contained in delay unit 3A has one input receive a decomposed pulse portion corresponding to the write pulse from pulse generator 2A, such as one of the seven decomposed pulse portions in the example shown in FIG. 3, and it has another input receive all of the phases of the multiphase clocks from said multiphase clock PLL 52A. Each of said delay tapping circuits 30A-l-k receiving inputs as sends the assigned delay quantity pertaining to the corresponding decomposed pulse portion to the decomposed pulse portion, and generates an output for the resulting delayed decomposed pulse portion. According to this invention, imparting of the delay quantity is carried out by selecting one of the phase clocks among the multiphase clocks having the corresponding delay quantity, and outputting it as a decomposed pulse portion. In FIG. 3, the delay and its quantity of each decomposed pulse portion are indicated by the arrows between FIGS. 3(c) and (d). Details of the delay tapping circuit will be explained later with reference to FIG. 4.

Pulse synthesizer 32A has plural inputs for receiving the delayed decomposed pulse portions from delay tapping circuits 30A-l-k. These pulse portions are synthesized in a form appropriate for use in circuits of the later stages (not shown in the figure). As a result, by means of timing adjustment, write pulses optimum for writing on an optical disk are generated at output terminal 7A. The optimized write pulses are shown in FIG. 3(d). In the example shown in this figure, all the delayed decomposed pulse portions are synthesized into a single portion. As shown in FIG. 3(d), by means of the optimized write pulses, the write laser for the optical disk is controlled at plural different levels, such as the bias power level, erasure power level, recording power level, etc., and the pits shown in FIG. 3(e) are formed on the optical disk.

The operation of pulse width controller A can be summarized as follows. In this device A, when the write data shown in FIG. 3(b) are received by input terminal 1A, multiphase clocks are generated by multiphase clock generator 5A from a reference signal related to said data or independent of said data. In synchronization with one phase of clock (FIG. 3(a)), pulse generator 2A generates write pulses (FIG. 3(c)) from the write data, and at the same time, the pulses are decomposed to form a set of decomposed pulse portions. Then, each of delay tapping circuits 30A-l-k selects one phase clock from the multiphase clocks having an assigned delay quantity with respect to the decomposed pulse portions, and outputs its delayed decomposed pulse portion. Then, the delayed decomposed pulse portions are synthesized by pulse synthesizer 32A to form optimized write pulses (FIG. 3(d)).

In the following, delay tapping circuits 30A-l-k will be explained in detail with reference to FIG. 4. Also, since the delay tapping circuits all have the same circuit constitution, an explanation will be provided only for delay tapping circuit 30A-k. Here, as an example, a delay tapping circuit is shown that executes tap delay at a 16-fold resolution with respect to the PLL clock period. As shown in FIG. 4, this delay tapping circuit can be generated roughly from the following parts: input terminal 300A that receives a pulse input as a decomposed pulse portion from pulse generator 2A shown in FIG. 2, delay assigning input terminal 302A that receives a binary 4-bit selection signal for assigning the delay quantity realized by said delay tapping circuit, input register 301A, timing adjusting register 304A, high-order register group 306A and low-order register group 308A, decoder 310A, selecting circuit 312A, and output terminal 314A generating a pulse output as the delayed decomposed pulse portion from said selecting circuit.

In more detail, input register 301A is a flip-flop circuit (F/F) that receives the pulse input at an input terminal and receives the phase 08 clock as the inverted clock of the phase 00 clock among the multiphase clocks from multiphase clock PLL 52A shown in FIG. 2 at a clock terminal. As a result, a pulse input in synchronization with phase 00 is output in synchronization with the phase 08 clock. That is, input register 301A plays a role in ensuring a sufficient time margin for next register 304A and high-order register group 306A. In other words, by delaying the pulse input by ½ period (180°) of the PLL clock, it is possible to maintain the relative delay of pulse P1 input to each register of high-order register group 306A constant at all times. Also, as shown in FIG. 5, multiphase clocks generated by multiphase clock PLL 52A are composed of clocks of phases 00-15. Here, pulse P1 of input register 301A is sent to the inputs of the various registers of high-order register group 306A that receive phase 00-phase 07 clocks. Timing adjusting register 304A is a F/F wherein the input terminal receives pulse output P1 from input register 301A, and wherein the clock terminal receives the phase 00 clock. As a result, the output of input register 301A works such that it delays the PLL clock by ½ period (with a phase of 180). Pulse P2 of said timing adjusting register 304A is sent to the inputs to the various registers of low-order register group 308A that receive phase 08-phase 15 clocks. This timing adjusting register 304A also plays a role in ensuring a sufficient time margin for next low-order register group 308A. As a result, it ensures that low-order register group 308A responds well to phase 08-phase 15 clocks present in the same PLL clock period as phase 00-phase 07 clocks.

High-order register group 306A is composed of eight registers set side-by-side. Each register is made of a F/F wherein the input terminal receives pulse P1 and the clock terminal receives the corresponding phase clock among phase 00-phase 07 clocks. These F/Fs work such that pulse P1 is delayed by a time corresponding to the phase delay of the received phase clock (θ×3 in the case of phase 03) and is then output. From another viewpoint, the corresponding phase clock is selected for use as the timing of generation of the delayed pulse. On the other hand, although low-order register group 308A is also composed of eight registers set side-by-side like with the high-order register group, it differs from the high-order register group in that its various F/Fs have the input terminals receive pulse P2, and they receive phase 08-phase 15 clocks as phase clocks, respectively.

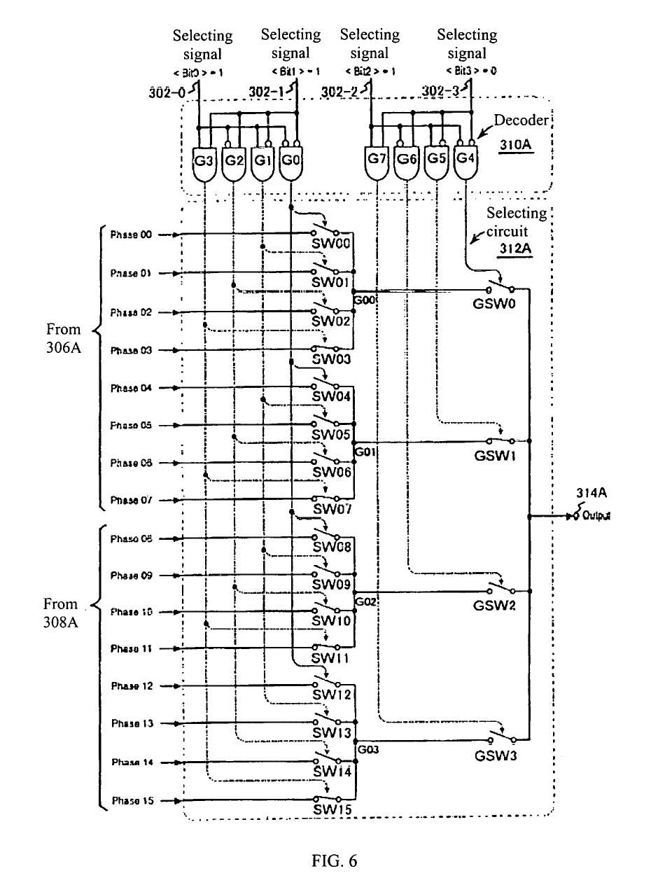

Decoder 310A has an input for receiving a 4-bit selection signal, and it generates an F/F output corresponding to the delay quantity represented by the selection signal, that is, it generates at its output an F/F selection signal indicating selection of one F/F output among high-order register group 306A and low-order register group 308A. The decoder may be composed of any logic circuit. One embodiment will be explained later with reference to FIG. 6.

Selecting circuit 312A has an input for receiving the F/F selection signal from decoder 31A, and inputs for receiving F/F outputs of register groups 306A and 308A. In operation, said selecting circuit 312A selects the F/F output represented by the F/F selection signal, and sends the selected F/F output to output terminal 314A. This selecting circuit may be made of any logic circuit. An embodiment will be explained with reference to FIG. 6.

In the constitution, for overall delay tapping circuits 30A-l-k, with respect to the pulse input received by input terminal 300A, by means of the 4-bit selection signal received at delay assigning input terminal 302A, a phase clock is selected among the multiphase clocks delayed by a delay quantity assigned by the selection signal, so that the delayed pulse output is generated at output terminal 314A in the operation.

In the following, with reference to FIG. 6 decoder 310A and selecting circuit 312A shown in FIG. 4 will be explained in detail, respectively. First of all, explanation will be provided for selecting circuit 312A. This circuit 312A is composed of four low-order switch groups SW00-03, SW04-07, SW08-11, and SW12-15, and four high-order group switches GSW0-3. More specifically, the outputs from the 16 F/Fs contained in register groups 306A and 308A shown in FIG. 4 are divided into four groups, and the four low-order switch groups are allotted to these F/F output groups, respectively. That is, the input terminals of switches SW00-03 are connected such that they receive phase 00-03 clocks (to facilitate explanation, the F/F outputs are identified as phase 00-03 clocks, respectively), respectively, and, by connecting the output terminals of these switches, group output GO0 is formed. Each of said switches SW00-03 has a control input for receiving a signal for controlling ON/OFF of the switch, and, only when a switch is ON, is its input generated as group output GO0. Similarly, the input terminals of switches SW04-07 receive phase 04-07 clocks, respectively, and form group output GO1. Also, the input terminals of switches SW08-11 receive phase 08-11 clocks, respectively, and they form group output GO2. The input terminals of switches SW12-15 receive phase 12-15 clocks, respectively, and they form group output GO3. On the other hand, group outputs GO0-GO3 are connected to the input terminals of group switches GSW0-3, respectively, and the output terminals of these switches are connected to each other and to output terminal 314A. Also, group switches GSW0-3 each have a control input for receiving a signal for controlling ON/OFF. In this circuit constitution, the one-out-of-16 selecting circuit can be formed by setting five switch groups, each of which is composed of four switches in the same constitution. In this constitution, no matter what path is selected, it always passes through identical switching. Consequently, it is possible to select signals at the same transmission delay.

On the other hand, for decoder 310A, in order to assign one out of 16 different delay quantities by 4-bit selecting signal, it is composed of four low-order AND gates G0-G3 and high-order AND gates G4-G7. For the low-order AND gate, by means of connection of the inverter and wiring shown in the figure, as the low-order two bits (bits 0 and 1) are incremented from 0 to 1, the high output moves from G0 to G3. As a result, one switch among the four in a low-order switch group is turned ON. On the other hand, for high-order AND gates G4-G7, by means of connection of the inverter and wiring shown in the figure, as the high-order two bits (bits 2 and 3) are incremented from 0 to 1, the high output moves from G4 to G7, so that one switch among the four high-order group switches is turned ON. As a result, by means of the 4-bit selection signal, operation is performed such that one of the 16 F/F outputs is selected and output to output terminal 314A. In FIG. 6, the case is shown when the 4-bit selection signal is “0111 (07H).” In this case, the low-order two bits turn ON SW03, 07, 11, 15, and the high-order two bits turn ON GSW1 only. Consequently, the eighth clock 07 represented by “0111 (07H)” is selected and output.

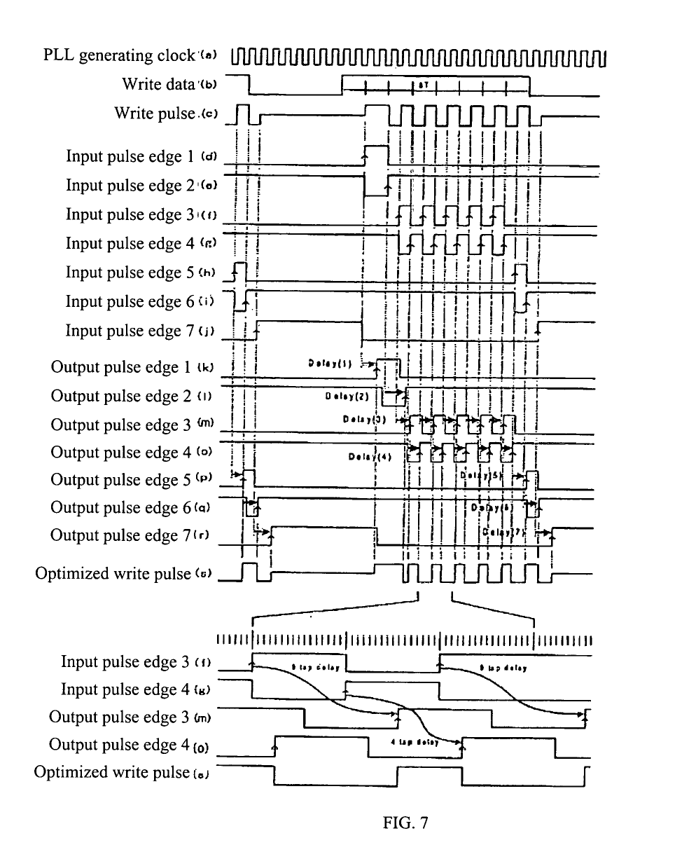

In the following, with reference to FIG. 7, the overall operation of pulse width controller A having said delay tapping circuit 30A will be explained. Also, FIG. 7 shows the timing diagram of FIG. 3 in more detail. The PLL clock, write data and write pulse are the same as therein. As can be seen from FIG. 7, while pulse generator 2A generates the write pulse shown in the figure (FIG. 7(c)), it decomposes the write pulse, and generates seven input pulse edges 1-7 (FIGS. 7(d)-(j). That is, it generates rise portion 1 of the first pulse, and fall portion 2 of the first pulse as an inversion of said rise portion. In addition, it also generates rise portion 3 of an intermediate pulse, fall portion 4 as an inversion of said rise portion, rise portion 5 of the last pulse, and fall portion 6 as an inversion of said rise portion, as well as end edge 7 of the cooling pulse. In the various corresponding delay tapping circuits in delay unit portion 3A, these decomposed pulse portions generate output pulse edges 1-7 shown in the figure (FIGS. 7(k)-(r)) by imparting corresponding delays 1-7 assigned by the 4-bit selection signal, respectively. Also, the delay of the pulse is controlled for the rise and fall, respectively. For example, as shown enlarged in the lower portion of FIG. 7, the delay applied on input pulse edge 3, that is, the rising edge of the pulse, is a delay provided by a 9-tap delay, that is, the phase 08 clock. On the other hand, the delay applied on input pulse edge 4, that is, the falling edge of the same pulse, is a delay provided by a 4-tap delay, that is, the phase 03 clock. In this way, input pulse edge 3 is delayed by 9 taps and edge 4 is delayed by 4 taps, and they are then synthesized. As a result, a write pulse (s) with a narrow signal width (small DUTY) can be obtained. As can be seen from the above description, each of the delay tapping circuits performs delay only for one decomposed pulse portion. By synthesizing the output pulse edges generated in this way by means of the rise portions alone at pulse synthesizer 32A, an optimized write pulse (FIG. 7(s)) is formed. Also, in the example shown in FIG. 7, the delay quantity that can be applied on the pulse edges is from 0 to the maximum, and is 15/16 the period of the PLL clock (FIG. 7(a)). Also, the delay for each pulse edge is one PLL clock period, and it is added as the delay from the PLL clock edge with its pulse edge at the position of 0.

The advantages of pulse width controller A of this invention explained above are as follows. According to this invention, as delay quantity is imparted by means of multiphase clocks, compared with the prior art that uses delay elements with a fixed delay, the advantage of this invention is that it is less affected by the manufacturing process, ambient temperature, power source voltage, etc. Also, the multiphase clocks are shared by all of the delay tapping circuits, and the same phase clock is used at plural tap positions (one of each of register groups 306A and 308A) that output the delay pulse in the delay tapping circuits as that used at the tap positions corresponding to all the other delay tapping circuits. Consequently, it is possible to impart the same delay quantity at the same tap position, even in different delay tapping circuits. This feature contrasts with a delay tapping circuit using conventional delay elements, in which it is hard to provide the same delay quantity correctly even at the same tap position due to the manufacturing process and other factors.

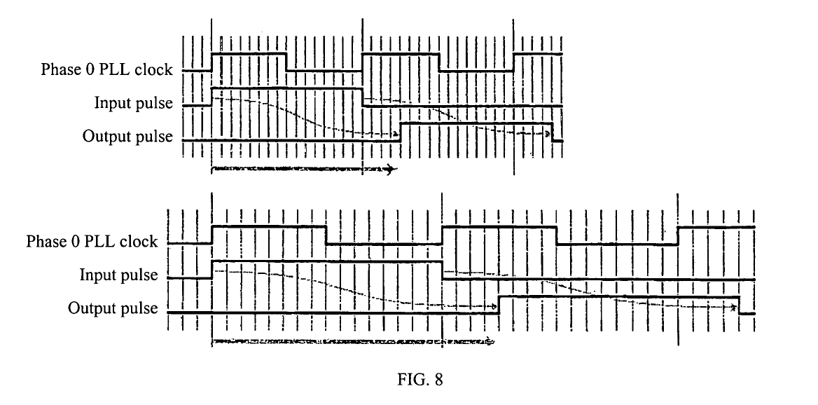

Also, as explained with reference to FIG. 8, in the method of this invention using multiphase clocks, even when the frequency of the PLL clock varies, the relative delays realized at the various tap positions of the delay tapping circuit can be kept constant at all times. This is an advantage. Here, the relative delay refers to the delay with respect to the duration of the PLL clock period as a reference. That is, when a delay of, say, 4 taps is imparted to the input pulse, as shown in the lower portion of FIG. 8, when the PLL clock period is long as in the case of a low speed multiple write operation, the absolute delay quantity due to the 4-tap delay is relatively large. Also, as shown in FIG. 8, the delay of a period of the PLL clock is the time margin. On the other hand, as shown in the upper portion of FIG. 8, when the PLL clock period is short as in the case of a high speed multiple write operation, the absolute delay quantity due to the 4-tap delay is relatively small. Also, as shown in FIG. 8, the relative delay in one period of the PLL clock is constant and is a delay of 4/16 the PLL clock period. Consequently, in this invention, it is possible to maintain a constant relative delay. Consequently, one can easily handle the write speed over a wide range of write speed multiples, from a low write speed multiple to a high write speed multiple, on optical disks. In other words, even when the frequency of the PLL clock is changed, although the absolute value of the resolution changes, the relative resolution is kept at 1/16 of the PLL clock period. This is an effect of this invention.

In the following, the circuit constitution of an embodiment of a 16-phase multiphase clock PLL 52A will be explained with reference to FIG. 9. As shown in the figure, with a structure well known in this field, said multiphase clock PLL 52A is composed of phase comparator 520, frequency divider 522, loop filter 524, and ring oscillator unit 526. Also, with a well known structure, ring oscillator unit 526 is prepared by setting and connecting eight differential buffers 526-0-7 in an annular configuration. Each differential buffer changes the signal transmission delay depending on the supplied bias current. Also, ring oscillator unit 526 has an output circuit composed of eight differential buffers 526-10-17.

More specifically, for phase comparator 520, one input is connected to input terminal 500 that receives a reference or standard frequency clock, while the other input is connected to the output of frequency divider 522 that sets a frequency multiple of the PLL, and phase and frequency comparison is performed between the output clock of the frequency divider and the reference frequency, with its result generated at its output. Loop filter 524 having an input connected to the output of the phase comparator smoothens the output signal of the phase comparator, and feeds it to ring oscillator unit 526 as the bias current is output. The output of said loop filter 524 is connected to the bias inputs of differential buffers 526-0-7 in ring oscillator 526, and the output of each differential buffer section of ring oscillator 526 is connected to the input of the corresponding output differential buffer among output differential buffers 526-10-17. Each of said output differential buffers 526-10-17 has a non-inverted output and an inverted output. As a result, pairs of clocks, such as the pair of phase 00 and phase 08 clocks, the pair of phase 01 and phase 09 clocks, the pair of phase 02 and phase 10 clocks, etc., are taken out. Also, by connecting the phase 00 clock output from differential buffer 526-10 to the input of frequency divider 522, a PLL loop is formed.

For the constitution, by means of the feedback loop from phase comparator 520 to ring oscillator 526 composed of loop filter 524 differential buffers 526-1-7 and 526-10-17, and to frequency divider 522, control is performed so that the phase of the clock in the output of frequency divider 522 is in agreement with the phase of the reference frequency clock. Consequently, in annular differential buffers 526-0-7, even when there is dispersion in the signal transmission delay quantity due to variation in the manufacturing process, automatic correction can be performed, and an oscillation clock in synchronization with the reference frequency clock can be obtained. Also, because annular differential buffers 526-0-7 have the same constitution and have the same bias current fed to them, the transmission delays of the differential buffers are all nearly the same. Because such differential buffers are set in a ring-shape to form a ring oscillator, from the connecting line that connects differential buffers 526-0-7 to each other, multiphase clocks can be retrieved at a resolution that equally divides the basic clock (phase 00 clock in this case) via output differential buffers 526-10-17. In this case, the number of annular differential buffers that form the ring oscillator is determined according to the necessary resolution (phase number). Consequently, with the circuit constitution shown in FIG. 9, it is possible to realize annular differential buffers with a number one half the phase number. Consequently, in the example of the 16-phase clock PLL shown in FIG. 10, eight=16/2 annular differential buffers 526-0-7 are used.

In the following, the embodiment of optical disk recorder B using the pulse width controller of this invention will be explained with reference to FIG. 10. FIG. 10 shows only the write portion of the recorder. Also, letter “B” is attached to the corresponding reference numbers for the structural elements corresponding to the structural elements in pulse width controller A shown in FIG. 2. As shown in the figure, this optical disk recorder B is composed of input terminal 1B that receives the host data, pulse generator 2B, multiphase clock generator 5B connected to input terminal 50B that receives the rise clock, delay unit portion 3B, as well as laser controller 8B and laser 9B for writing on an optical disk. Optical disk recorder B has a basic constitution identical to that of pulse width controller A shown in FIG. 2. Consequently, a detailed explanation will not be provided for pulse synthesizer 32B of pulse generator 2B and delay unit portion 3B.

As shown in the figure, pulse generator 2B is composed of encoder 21 that encodes the host data according to the format specifications of a CD/DVD, EFM/ESM modulator 22 that generates a write pit sequence as shown in FIG. 3(b) while the data encoded to 8 bits are modulated to 14-bit (CD) or 16-bit (DVD) data, and formatter 23 that determines the pulse sequence and pulse width of optimum write pulses corresponding to the type of disk medium and the EFM/ESM signal length. Said encoder 21, modulator 22 and formatter 23 have well known constitutions with functions determined in CD and DVD specifications. When formatter 23 is connected to pulse generator circuit groups 24-28, it is also connected to one of the delay tapping circuits 30B-l-k. Formatter 23 instructs the structure of the pulses for pulse generator circuit groups 24-28, and it indicates the 4-bit tap adjustment quantity for delay tapping circuits 30B-l-k. Also, pulse generator groups 24-28 connected in series as a sequence generate pulses according to the pulse structure determined by formatter 23. That is, as shown in the figure, pulse generator circuits are set corresponding to the various types of pulses, such as the first pulse, an intermediate pulse, the last pulse, and the cooling pulse. Each pulse generator circuit generates a pos pulse indicating the pulse generation point (for example, see: FIG. 7(d)) and a neg pulse indicating the end point (for example, see: FIG. 7(e)). Last cooling pulse generator 28 only generates a pulse indicating the end of the cooling period (for example, see: FIG. 7(j)), and the starting point of cooling adopts the pulse indicating the end point of the last pulse (see FIG. 7(i)). Here, as shown in FIG. 11, the pos pulse is a pulse having a rising edge at the front edge in agreement with the pulse generating point or the rising edge, and the neg pulse is a pulse having the same length and with the rising edge at the front edge in agreement with the end point or falling edge of the corresponding pulse. Multi-pulse generators 25, 26 that function as intermediate pulse generators are set as two divided circuits as an attempt to increase the operation frequency of delay tapping circuit 30B. Said generators 25, 26 generate odd number and even number of pulses, respectively, with the same pulse width for these pulses. In addition, FIG. 10 shows a list of examples of pulse constitution for various bit lengths pertaining to an ESM signal (for a DVD). That is, for different signal lengths 3T-11T, 14T, the number of the first pulse, the intermediate multi-pulses, the last pulse, and the cooling pulse are shown.

FIG. 11 is a diagram illustrating an example of the output waveforms of pulse generator circuits 24-28 in this pulse constitution example. As shown in the figure, for the signal length of “11T,” there are the following pulses: one first pulse, seven intermediate pulses, one last pulse, and one cooling pulse. When the signal length is “5T,” it is understood that only one intermediate pulse is present. Also, in the case of the shortest signal length “3T,” first pulse and intermediate pulses are both absent. Also, the constitutions of the pulses are different for different specifications of the media. In the examples shown in FIGS. 3 and 7, the pulses are for CD-RW. In the example shown in FIG. 11, the pulses are for DVD-RAM. Consequently, the write pulse in the example of the waveform shown in FIG. 11 is different from those shown in FIGS. 3 and 7. In addition to the peak power level, the bias power level for erase, and the power level for bias, there is also a bias power level for cooling.

In the following, a detailed explanation will be provided for the portion of pulse synthesizer 32B shown in FIG. 10. As an example, pulse synthesizer 32B is composed of several edge trigger type SR flip-flop circuits (F/F) 321-324, 327, 328, and OR gates 325, 326. More specifically, F/F 321 has a set input that receives the pos pulse of the first pulse through delay tapping circuit 30B-1, and reset input that receives the neg pulse of the same first pulse through delay tapping circuit 30B-2. Consequently, a delayed first pulse is generated at its output. Next F/F 322 has a set input that receives the pos pulse of multi-pulses 1 as intermediate pulses through delay tapping circuit 30B-3, and a reset input that receives the neg pulse of the same multi-pulses 1 through delay tapping circuit 30B-4, and delayed multi-pulses 2 are generated at its output. Similarly, F/F 323 has a reset input that receives the pos pulse of multi-pulses 2 through delay tapping circuit 30B-5, and a reset input that receives the neg pulse of the same multi-pulses 2 through delay tapping circuit 30B-6, and it generates an output of delayed multi-pulses 1. Also, F/F 324 has a set input that receives the pos pulse of the last pulse through delay tapping circuit 30B-7, and a reset input that receives the neg pulse of the same last pulse through delay tapping circuit 30B-8, and it generates a delayed last pulse output. OR gate 325 having inputs for receiving the outputs of said F/F 321-324, respectively, synthesizes a single received delayed pulse, and it generates a peak control pulse that becomes high during a certain period on the peak level of the first pulse, the intermediate pulses, and the last pulse. On the other hand, F/F 327 that controls cooling has its set input receive the neg pulse of the delayed last pulse, and has its reset input receive the delayed last pulse of the cleaning pulse. As a result, a cleaning control pulse that becomes high from the fall of the last pulse to the end time of the cleaning pulse is generated. Finally, for F/F 328 for erase control, the set input receives the delayed cleaning end pulse, and the reset input receives, by means of OR gate 326, the pos pulse of the first pulse of the following signal or the pos pulse of the last pulse (as listed in the table of FIG. 10, there may be no first pulse), and, in the output, it generates an erase control pulse that becomes high during the period from the delayed cooling end pulse to the start of the next pulse. In this way, the pulse synthesizer generates the peak control pulse signal in controlling the peak power needed for writing of pits on an optical disk using a laser beam, the cooling control pulse signal that controls the cooling power for shaping the end of the post-write pit, and the erase control pulse signal that controls the erase power for erasing the pits that have been written. Also, the bias power is controlled so that writing is not carried out other than in the period of peak, cooling and erase.

As explained above, by synthesis of the delay pulses from the delay tapping circuits, pulse synthesizer 32B forms a pulse for controlling the laser. As shown in FIG. 10, the control pulse formed in this way is supplied to the peak control input, cooling control input and erase control input of laser controller 8B. As a response to these control pulses, laser controller 8B controls the power of laser 9B for following write, so that write of data on the optical disk is executed. The decomposition system shown in FIGS. 10 and 11 is merely an example. This invention is not limited to it, and one may adopt other decomposition systems.

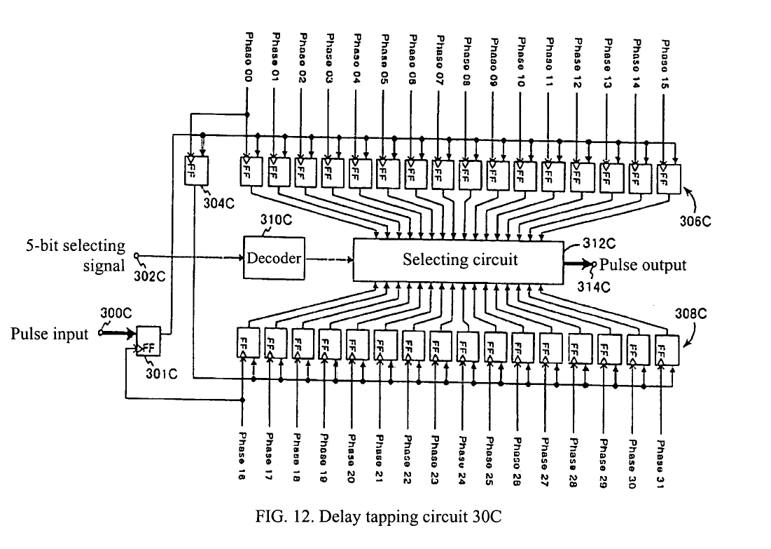

In the following, delay tapping circuit 30C in another embodiment will be explained with reference to FIG. 12. Because this delay tapping circuit 30C has basically the same constitution as that of delay tapping circuit 30A in FIG. 4, letter “C” is attached to the same part numbers to represent the corresponding structural elements. The purpose of said delay tapping circuit 30C in FIG. 12 is to improve the relative resolution of delay as compared with that shown in FIG. 4. As a method for realizing this purpose, the phase number of the multiphase clocks and the number of registers of the corresponding register group are increased. More specifically, the phase number of the multiphase clocks is doubled to 32 (phase 00-phase 31. Also, the number of registers contained in high-order register group 306C and low-order register group 308C is doubled, and registers (F/F) with a phase number of 32 are set. In order to select from these 32 register outputs, the selection signal applied on input terminal 302C has 5 bits. Corresponding to this, decoder 310C and selecting circuit 312C have the same architecture as that shown in FIG. 6, and they form a one-out-of-32 selecting circuit. In this way, by increasing the phase number of the multiphase PLL clocks and the number of registers at will, one can easily increase the relative resolution. Consequently, it is easy to provide a relative resolution matching correctly the correctness required for the prescribed timing adjustment.

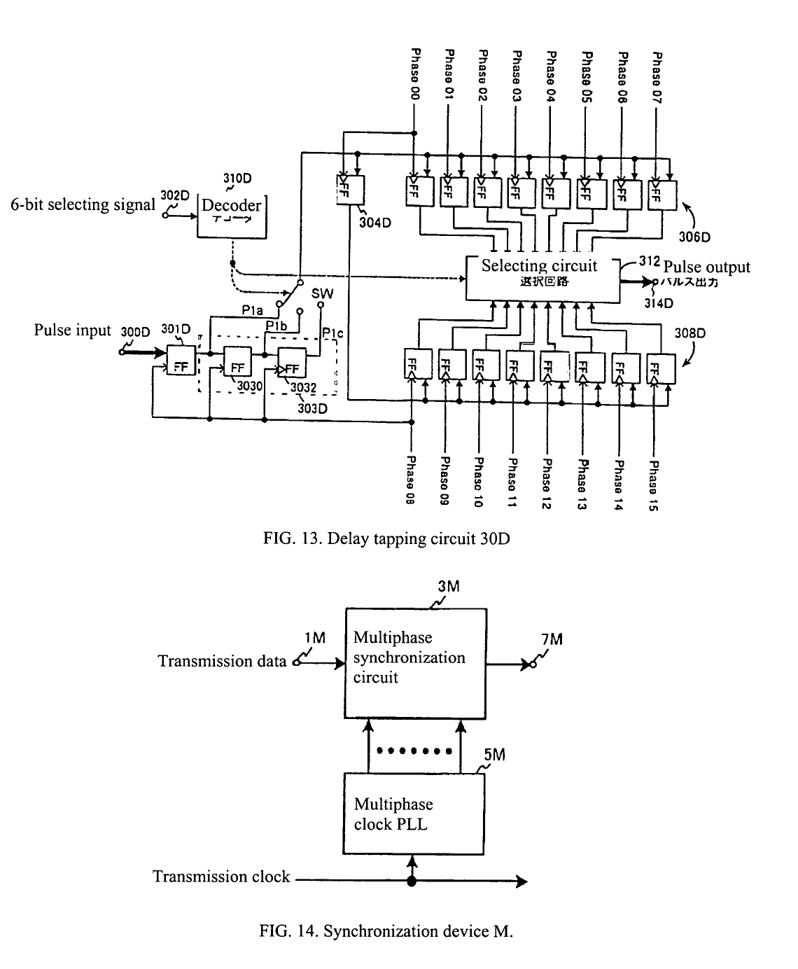

In the following, delay tapping circuit 30D as another embodiment will be explained with reference to FIG. 13. Because this delay tapping circuit 30D has basically the same constitution as that of delay tapping circuit 30A in FIG. 4, letter “D” is attached to the same part numbers to represent the corresponding structural elements. The purpose of said delay tapping circuit 30D in FIG. 13 is to extend the delay quantity range of the absolute delay, that is, the delay setting range, as compared with that shown in FIG. 4. As a method for realizing this purpose, the application position of the multiphase clocks is delayed in units of one period of the multiphase clocks. That is, in said delay tapping circuit 30D, in addition to input register 301D, delay setting range extending portion 303D and switch SW are set. Delay setting range extending unit 303D has two registers having the same constitution as input register 301D, that is, first range extending register 3030 and second range extending register 3032. These extending registers have inputs that receive the output of the register in the preceding section, and connection is performed so that phase 08 clock is received at the clock terminal. Consequently, from output pulse P1a of input register 301D, extending register 3030 generates output pulse P1b delayed by one period of the PLL clock, and extending register 3032 generates output pulse P1c that is delayed by another period. Outputs P1a, P1b, P1c of said input register 301D, extending register 3030, and extending register 3032 are connected to the three input terminals of switch SW, respectively, and this switch responds to the switch control input from decoder 310D, and lets any of the three register output to the output terminal. With the constitution, by adding an extending register, the delay range is doubled, and by adding two extending registers, the delay range is tripled. In this embodiment, for decoder 310D, by receiving an input 6-bit selecting signal, in addition to selecting circuit 312D, it is necessary to generate a selecting signal that controls switch SW. Amendment of the circuit for this purpose is obvious to specialists as shown in FIG. 7. According to this invention, by means of this delay setting range extension method, a delay setting range can be realized easily by increasing the number of registers. Compared with the prior art using conventional fixed delay elements wherein the element number has to be increased to extend the delay range, the extension method of this invention can be realized in a much simpler way.

In the following, another embodiment of the timing adjustment method of this invention will be explained for synchronizing device M of the digital transmission data with reference to FIG. 14. In the interface receiving portion with changing signal transmission speed (such as connection between the clock reproduction unit and the demodulator unit in the DVD/CD regenerating device that performs a CAV read operation), the timing adjustment method of this invention can also be used for correcting the phase deviation of the digital transmission data and the transmission clock. That is, even when the transmission speed of the digital signal is changed, by setting the delay tap just as in the delay tapping circuit, it is possible to maintain an optimum state at all times for the margin balance of the setup time in the synchronization device (the time from change in the D input of F/F to input of CLK) and of the hold time (the time for holding the D input from CLK input of F/F).

In the following, explanation will be provided for the case when a gate delay is adopted using fixed delay elements as in the prior art. In the prior art, when the frequency rises, phase inversion may take place. More specifically, it would be ideal if the transmission data and transmission clock reached the synchronization circuit of the data receiving unit with the same delay. However, in reality, there is a certain deviation. Also, in a system prone to jitter in the transmission system, spilling may take place in handling of data in the synchronization circuit. Consequently, it is necessary to adjust to ensure that the setup time and hold time become the same. When a gate delay is adopted in their adjustment, when the optimum setting is made assuming a low transmission frequency, and when the frequency increases, the margin becomes smaller for either the setup time or the hold time, and the phase goes around for 1 period. On the other hand, when the optimum setting is performed at a high frequency, and when the frequency decreases, the other margin becomes smaller. In this case, although the phase does not go around for one period, the shaking amplitude of jitter of the transmission data is proportional to the period of the transmission clock, and this is a problem in this system. By using the timing adjustment method of this invention, the problem can be solved.

More specifically, as shown in FIG. 14, synchronization device M is composed of input terminal IM that receives digital transmission data, multiphase synchronization circuit 3M, multiphase clock PLL circuit 5M, and output terminal 7M that outputs synchronized transmission data. More specifically, multiphase synchronization circuit 3M has an input connected to input terminal 1M and an input for receiving the multiphase clocks from multiphase clock PLL circuit 5M, and its output is connected to output terminal 7M. On the other hand, multiphase clock PLL circuit 5M has an input for receiving a transmission clock that has its input transmitted separately with respect to the digital transmission data. Also, multiphase clock PLL circuit 5M can have the same circuit constitution as that shown in FIG. 2 or FIG. 9.

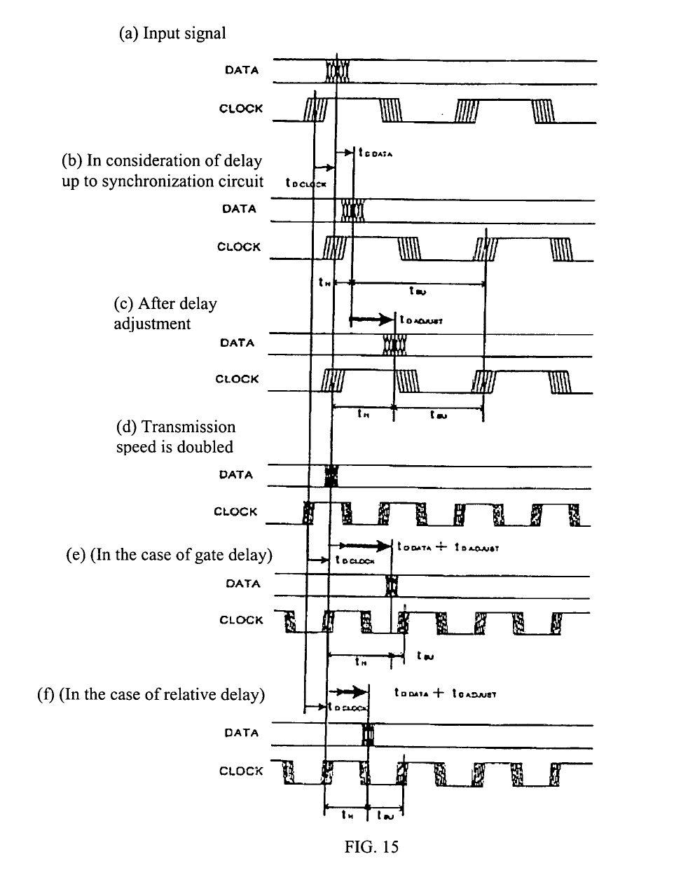

In the following, the overall operation of said synchronization device M will be explained as compared with the case when a gate delay is adopted. FIG. 15(a) is a diagram illustrating digital transmission data as the input signal and the transmission clock. As the input signal passes through the transmission system, delay is imparted to it before it reaches the synchronization circuit. In this case, the delay quantity of the data may be unequal to that of the clock. As shown in FIG. 15(b), the data are delayed by time t_{D DATA} from the signal input, and the clock is delayed by a longer time t_{D CLOCK}. In this case, the data change point and the rise point of the clock become nearer to each other, and, as can be seen from the figure, hold time t_{H} becomes much shorter than setup time t_{SU}. Consequently, data spilling may take place easily in synchronization. In consideration of this problem, as shown in FIG. 15(c), delay adjustment is performed for the data, and adjustment delay time t_{D ADJUST} is further applied on the data. As a result, hold time t_{H} becomes nearly as long as setup time t_{SU}. However, when the data transmission speed is, say, doubled, the input signal becomes shorter as shown in FIG. 15(d), so that when said delay adjustment is performed by means of a fixed gate delay, as shown in FIG. 15(e), the delay of the data becomes t_{D DAT}+t_{D ADJUST}. As a result, contrary to expectation, hold time t_{H} becomes much longer than setup time t_{SU}, and the margin balance also increases and collapses. In such case, however, if synchronization device M of this invention is used, it is possible to provide a constant relative delay. Consequently, as shown in FIG. 15(f), by shortening the adjustment delay time t_{D ADJUST} corresponding to the transmission speed, one can maintain an optimum margin balance.

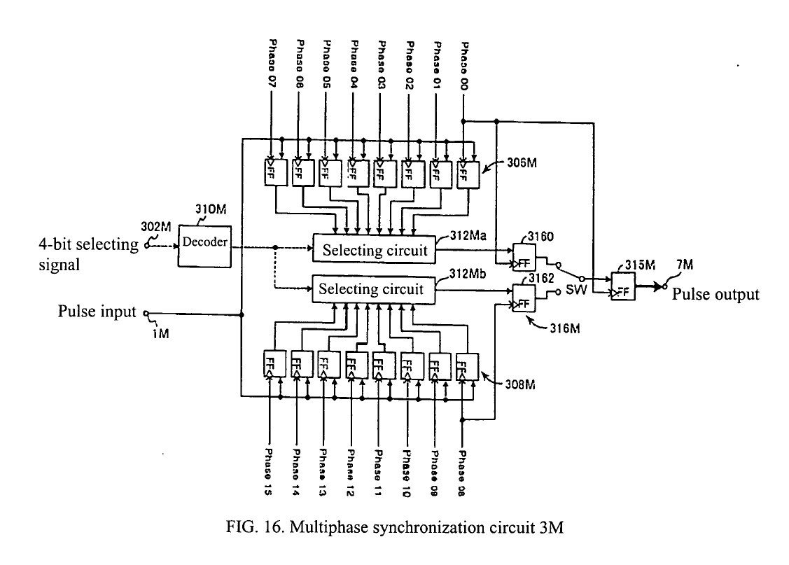

In the following, by using FIG. 16, an explanation will be provided for the constitution of an embodiment of multiphase synchronization circuit 3M shown in FIG. 14. For the synchronization device, the event as the object of timing adjustment refers to a single event of the transmission data instead of the plural events shown in FIG. 2. Consequently, the circuit constitution of multiphase synchronization circuit 3M is similar to one delay tapping circuit 30A of pulse width controller A shown in FIG. 2, but it does not have pulse generator 2A and pulse synthesizer 32A shown in FIG. 2. More specifically, multiphase synchronization circuit 3M is the same circuit as those shown in FIGS. 2 and 4, and it has input terminal IM for recording the pulse input as data, high-order register group 306M, low-order register group 308, and output terminal 7M. In addition, as characteristic elements, said multiphase synchronization circuit 3M also has a pair of selecting circuits 312Ma, 312Mb, selecting register 316M, switch SW, and output register 315M. In the following, explanation will be provided mainly for the features different from those in the circuit shown in FIG. 4. That is, instead of feeding through an input register, the pulse input is fed directly to the inputs of the various registers (F/F) in high-order and low-order register groups 306M, 308M. Consequently, the various F/Fs generate at their outputs the pulses delayed corresponding to phase 00-phase 15 clock delays and within the range of one new PLL clock period that starts immediately after the time of arrival of the pulse input. Selecting circuit 312Ma that receives the F/F outputs within high-order register group 306M receives the former-half eight delayed pulses (F/F outputs receiving phase 00-phase 07 clocks) with different delay quantities, and selecting circuit 312Mb that receives the F/F outputs within low-order register group 308M receives the latter-half eight delayed pulses (F/F outputs receiving phase 08-phase 15 clocks) with different delay quantities. For these selecting circuits, by means of a signal from decoder 310M that receives a 4-bit selection signal, selecting circuit 312Ma sends a delayed pulse selected from the former-half eight delayed pulses to the output. F/F 3160 within selected register 316M has its input connected to the output of selecting circuit 312Ma, and it is connected such that its clock terminal receives the phase 00 clock, and re-synchronization is applied by means of phase 00 for the signal pulse selected from the former-half eight delayed pulses.

Just as selecting circuit 312Ma, selecting circuit 312Mb also feeds a pulse selected from any of the latter-half eight delayed pulses to the input of F/F 3162 within selecting register 316M. Said F/F 3162 is connected such that the phase 08 clock is received at the clock terminal, and, by means of the phase 08 clock, re-synchronization is applied on the pulse selected from the latter-half eight delayed pulses. Switch SW connects the selecting register on the side of the selecting circuit that generates the selected delayed pulse to the input of output register 315M. The clock terminal of output register 31 5M is connected so that the phase 00 clock is received. Consequently, the operation is such that the pulse output is generated in synchronization with the phase 00 clock.

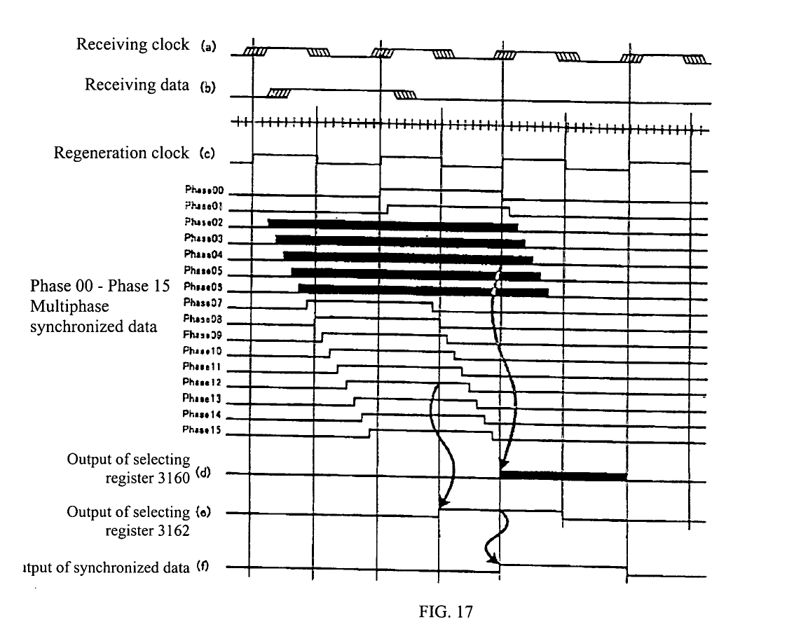

In the following, the overall operation of multiphase synchronization circuit 3M shown in FIG. 16 will be explained with reference to the timing diagram shown in FIG. 17. In this figure, as an example, operation in the case of synchronization with 12-phase clocks under the input condition that ensures minimum chance of generation of error in data reception is shown. First of all, in the case of reception of the clock and data by the system as shown in FIGS. 17(a), (b), multiphase clock PLL circuit 5M regenerates multiphase clocks in synchronization with the reception clock as shown in (c), that is, phase 00-phase 15 clocks. In the figure, in order to simplify the illustration, only the phase 00 clock is shown. As a response to the phase clock, F/Fs inside high-order and low-order register groups 306M, 308M generate multiphase synchronized data at their outputs. To facilitate explanation, FIG. 17 only shows phase 00-phase 15 as multiphase synchronized data. As shown in the figure, in this example, when fetching is performed according to phase 02-phase 06 clocks, as indicated by the solid black portions, timing violation takes place because the data variation point and the rise position of the phase clocks are near each other, so that the output data become undetermined. In this state, if phase 04 is selected in selecting circuit 312Ma, the output of selecting register 3160 also becomes unstable (indicated by the solid black portion). On the other hand, when phase 12 is selected in selecting circuit 312Mb, phase 12 clock (not shown in the figure) rises at nearly the center of the received data, so that multiphase synchronized data phase 12 becomes the most stable. Then, it is generated as a synchronized data output shown in FIG. 17(f) at output terminal 7M through selecting register 3162 and output register 315M. In this embodiment, the multiphase synchronized data output from selecting circuit 312Mb is not shifted to output register 315M that works directly at phase 00. Instead, after they are transferred to selecting register 3162 that works at phase 08, the phase opposite phase 00, the data are shifted to the phase of the phase 00 clock. The main purpose of F/F 3160 and 3162 of selecting register 316 is to ensure setup time during transmission between flip-flop circuits in company with the phase shift to phase 00.

In the above, various embodiments of this invention have been explained in detail. However, one may make various variations like those to be described below for the embodiments. First of all, in the embodiments, events refer to electrical events, especially transitions in signals and data. However, this invention can also be adopted in a case when events other then electrical events can be converted to electrical events. Also, for the electrical events, in addition to control signals, transition in data, etc., this invention may also be adopted for any other electrical events that require timing adjustment. Also, when an event group composed of plural events is taken as the object, in addition to the method for decomposition of events as described in the above embodiments, one may also adopt any other method to decompose the group into individual events or event groups. Also, here, an individual event may also include one or more transitions, etc.

Second, in the embodiments, the multiphase clock PLL is merely an example of a means that can equally divide the reference time range for performing timing adjustment and finely adjusting the timing adjustment quantity at the resolution of the inter-phase delay quantity among the various phases of the multiphase clocks (the inter-phase delay quantity of the clocks is taken as one unit of delay). As long as timing can be generated to equally divide in time the period of a reference clock by an unknown period, one can also adopt any other dividing means other than the multiphase clock PLL.

Third, for said multiphase clock PLL, synchronization is not a necessity for a wobble signal, transmission clock, or other frequency variable reference signal. For example, even when a single-phase high-speed fixed clock, such as a quartz clock or another fixed-frequency clock, is in use, depending on the specific application, a fixed delay resolution higher than the required resolution can be provided, and the effects of this invention can be effectively displayed. That is, compared with the conventional case when a gate delay is used, in this invention, it is possible to much more correctly determine the absolute delay quantity as the timing adjustment units. However, in this case, the advantage that the relative delay is constantly maintained cannot be realized. Also, for the phase clocks from the multiphase clocks, in addition to use as references in forming new events after timing adjustment, these phase clocks themselves may be used as events after timing adjustment.

Fourth, as the method for increasing the resolution of timing adjustment, one may use the scheme of increasing the multiphase clock frequency and/or the scheme of increasing the phase number of the multiphase clocks. Also, extension of the timing adjustment range may be realized by increasing the period of the multiphase clocks and/or increasing the delay setting range extension registers or other extending means.

Fifth, in addition to a CD, DVD, and other optical disks, this invention may also be adopted for any other recording media that adopt light in performing recording (such as Blu-ray, etc.). Sixth, the method for synchronization of the digital transmission data in the embodiments can be adopted in various cases ranging from long-distance data transmission of networks, etc. to short-distance data transmission within integrated circuits, etc.

As explained in detail above, according to this invention, it is possible to realize timing adjustment more correctly yet with a simpler constitution. More specifically, the timing adjustment quantity, such as the delay quantity, takes an equal division of the clock period or another reference time as one unit of the adjustment quantity. Consequently, although the relative adjustment quantity, such as the relative delay quantity, is of stepwise form in a multiple of the inter-phase delay quantity, the absolute delay quantity or another absolute adjustment quantity is nevertheless of step-less form based on a continuous change in the clock frequency. Consequently, in principle, the dilemma of insufficient resolution at high frequency and insufficient delay range at low frequency does not take place. This is an advantage. Also, in the conventional system using fixed delay elements, in order to obtain a sufficient delay range for low-frequency application, many delay elements are needed, and the circuit scale becomes larger. However, according to this invention, the same circuit scale is sufficient for realizing low-frequency application.

Also, by using a PLL or other feedback circuits, variation in the timing adjustment quantity is hardly affected by variation in manufacturing, as well as variations in power source voltage, ambient temperature, and other environment factors. In this case, variation between plural timing adjustment circuits (such as delay tapping circuits) is little affected by the influence of, say, the layout on integrated circuits. Also, for clock skewing between plural delay tapping circuits, too, automatic adjustment can be performed using the constitution wiring tools adopted in the device design, and the design operation can be carried out easily. As far as the size of the delay elements is concerned, it is possible to eliminate correlation between the required maximum absolute delay quantity and the size of the integrated circuit.

In addition, because the overhead delay (the delay when the setting delay is zero) is the delay in clock units and is independent of the intrinsic delay of the elements and the layout it can be predicted. Consequently, there is no need to worry about variation in delay quantity due to variation in the absolute delay quantity of the overhead delay adjustment circuit. As far as the risk of disappearance of the input signal is concerned, because the delayed output signal is reconstructed with F/Fs of the output section, there is no danger of disappearance even when the absolute delay quantity is large.

Also, according to this invention, even when a CLV write is performed on an optical disk under CAV rotation control in an optical disk recorder, there is still no need to perform zone division as would be needed in a conventional zone CLV, and, by forming a clock using a wobble signal pre-recorded as the reference signal of multiphase clock PLL on the optical disk, it is possible to realize seamless operation. In addition, even when the disk is under CAV control, it is still possible to change the delay quantity from the inner periphery to the outer periphery of the disk. Consequently, the tap setting value (selected tap position) in the delay tapping circuit during write is only of the order of fine adjustment. In addition, when the write speed on the optical disk is changed, the same relative delay can be obtained from the same delay tap position in the delay tapping circuit. Consequently, there is no need to change the delay tap setting (delay quantity setting). This is an effect of this invention.

In addition, in the timing adjustment method of this invention, there is no portion depending on processing technology, and it also has excellent resolution, delay range, and other extension properties. Consequently, it can maintain nearly the same architecture (the same circuit constitution, scale, etc.) in the future. This is an advantage.

1. A timing adjusting method characterized by the fact that in a timing adjusting method for adjusting the timing of an event, said timing adjustment of said event is performed based on multiphase clocks.

2. The timing adjustment method described in claim 1 characterized by the fact that said event is an electrical event.

3. The timing adjustment method described in claim 2 characterized by the fact that said electrical event refers to at least one transition that takes place between plural electrical states.

4. The timing adjustment method described in claim 3 characterized by the fact that said transition between electrical states rises or falls at prescribed pulses.

5. The timing adjustment method described in claim 4 characterized by the fact that said multiphase clocks are generated from a reference signal pertaining to said prescribed pulses.

6. The timing adjustment method described in claim 5 characterized by the fact that one selection from said multiphase clocks is used in forming said rise or fall of said prescribed pulses.

7. The timing adjustment method described in claim 3 characterized by the fact that said transition between electrical states is a transition in digital transmission data.

8. The timing adjustment method described in claim 7 characterized by the fact that said multiphase clocks are generated from the transmission clock of said digital transmission data.

9. The timing adjustment method described in claim 8 characterized by the fact that one selection from said multiphase clocks is used in forming a transition after timing adjustment in said digital transmission data.

10. A timing adjustment method characterized by the following facts:
in a timing adjustment method for adjusting the timing of an event, there are the following steps:
a multiphase clock generating step for generating multiphase clocks, with said multiphase clocks composed of plural phase clocks of different phases that represent plural different timing adjustment quantities applied on said event,
and a multiphase clock use step in which any one said phase clock from said multiphase clocks is used, and an event change timing signal representing the changed timing of said event is generated.

11. A timing adjustment method of an event group characterized by the following facts:
the timing adjustment method for adjusting the timing of an event group composed of plural events has the following steps:
a step in which said event group is decomposed into individual events,
and a step in which the timing adjustment method described in claim 10 is embodied for each of said decomposed events.

12. The timing adjustment method described in claim 10 or 11 characterized by the following facts:
there is also a step in which an event timing signal representing said timing of events is generated; in this step, said event timing signal is in synchronization with said multiphase clocks.

13. The timing adjustment method described in claim 10 or 11 characterized by the fact that it also has the fact that said multiphase clock generating step also contains a step in which said multiphase clocks are generated in synchronization with a reference signal related to said events.

14. The timing adjustment method described in claim 13 characterized by the fact that said multiphase clock is composed of plural phase clocks with equal spacing between them.

15. The timing adjustment method described in claim 14 characterized by the fact that said phase clock has a clock portion representing the corresponding timing adjustment quantity.

16. The timing adjustment method described in claim 14 characterized by the fact that said events are events on an optical disk recording medium.

17. The timing adjustment method described in claim 15 characterized by the following facts: the events on said optical disk recording medium are rise events and fall events of the write pulses in the pulse width adjustment of the write pulses for writing on said optical disk recording medium;
said write pulses are for determining the timing of control of output of the laser used in write on said optical disk recording medium.

18. The timing adjustment method described in claim 16 characterized by the fact that in said event timing signal generating step, said event timing signal is generated from said write pulses.

19. The timing adjustment method described in claim 17 characterized by the fact that there is also a step in which write pulses after a timing change are generated from said event change timing signal.

20. The timing adjustment method described in any of claims 13-19 characterized by the fact that said multiphase clock generating step also contains
a step in which said reference signal related to said events is obtained from the wobble signal of said optical disk recording medium.

21. The timing adjustment method described in any of claims 14-20 characterized by the fact that said optical disk recording medium has a rotation control system, such as a CAV system, zone CLV system, or CLV system.

22. The timing adjustment method described in claim 14 characterized by the fact that said events are events in digital transmission data.

23. The timing adjustment method described in claim 22 characterized by the fact that said multiphase clocks are generated from the transmission clock of said digital transmission data.

24. The timing adjustment method described in claim 10 or 11 characterized by the fact that said multiphase clock use step also contains the following steps:
a step in which an adjustment quantity input that assigns the timing adjustment quantity applied on said events is received,
and a selection step in which one said phase clock having said timing adjustment quantity corresponding to said adjustment quantity input is selected as said event change timing signal.

25. The timing adjustment method described in claim 24 characterized by the fact that said use step also contains
a step in which said event change timing signal is applied on said events.

26. The timing adjustment method described in claim 10 or 11 characterized by the fact that said timing adjustment is performed by timing delay.

27. The timing adjustment method described in claim 10 or 11 characterized by the fact that said plural different timing adjustment quantities are within a prescribed range.

28. A timing adjustment circuit characterized by the fact that a timing adjustment circuit for adjusting the timing of events is composed of the following means:
a multiphase clock generating means for generating multiphase clocks, with said multiphase clocks composed of plural phase clocks having different phases representing plural different adjustment quantities applied on said events,
and a multiphase clock use means that uses any one said phase clock selected from said multiphase clocks and generates an event change timing signal representing the changed timing of said events.

29. A timing adjustment circuit for an event group characterized by the fact that the timing adjustment circuit for an event group adjusts the timing of one event group composed of plural events, and it consists of the following means:
an event decomposition means that decomposes said event group into individual events,
and an event group timing adjustment means composed of timing adjustment circuits described in claim 28 for said various events, respectively.

30. The timing adjustment circuit described in claim 29 characterized by the fact that it contains a synthesis means that receives said event change timing signals generated by said timing adjustment circuits for said events in said event group and synthesizes them to generate a synthetic event change timing signal.

31. The timing adjustment circuit described in claim 30 characterized by the fact that said timing adjustment circuits set for said events, respectively, contain a common multiphase clock generating means.

32. The timing adjustment circuit described in claim 28 or 29 characterized by the fact that it also
contains a means for generating an event timing signal that represents timing of said events, with said event timing signal in synchronization with said multiphase clocks.

33. The timing adjustment circuit described in claim 32 characterized by the fact that said timing adjustment is performed by means of timing delay.

34. The timing adjustment circuit described in claim 32 characterized by the fact that said plural different timing adjustment quantities are within a prescribed range.

35. The timing adjustment circuit described in claim 34 characterized by the fact that said multiphase clock use means contains an enlarging means that receives said event timing signal and, by delaying the event timing signal, enlarges said timing adjustment quantity by means of said multiphase clocks alone.

36. The timing adjustment circuit described in claim 28 or 29 characterized by the fact that said multiphase clock generating means contains
a PLL circuit means that generates said multiphase clocks in synchronization with the reference signal pertaining to said events.

37. The timing adjustment circuit described in claim 36 characterized by the fact that said events are events on an optical disk recording medium.

38. The timing adjustment circuit described in claim 37 characterized by the following facts: said events on the optical disk recording medium are rise events and fall events of the write pulses for write on said optical disk recording medium in pulse width adjustment of said write pulses, and said write pulses are for determining the timing for control of output of a laser used in write on said optical disk recording medium.

39. The timing adjustment circuit described in claim 38 characterized by the fact that said event timing signal generating means generates said event timing signal from said write pulses.

40. The timing adjustment circuit described in claim 39 characterized by the fact that said multiphase clock use means also contains
a means for generating write pulses after a timing change from said event change timing signal.

41. The timing adjustment circuit described in any of claims 36-40 characterized by the fact that
said multiphase clock generating means contains
a means for obtaining a reference signal pertaining to said events from the wobble signal of said optical disk recording medium.

42. The timing adjustment circuit described in claim 41 characterized by the fact that said optical disk recording medium has a rotation control system, such as a CAV system, zone CLV system, or CLV system.

43. The timing adjustment circuit described in claim 28 or 29 characterized by the fact that said multiphase clock use means contains the following means:
a means for receiving an adjustment quantity input that assigns the timing adjustment quantity applied on said events,
and a selection means that selects one said phase clock having said timing adjustment quantity corresponding to said adjustment quantity input as said event change timing signal from said multiphase clocks.

44. The timing adjustment circuit described in claim 43 characterized by the fact that said multiphase clock use means also
contains an application means for applying said event change timing signal on said events.

45. A type of pulse width adjustment device for use in an optical disk recorder characterized by the fact that the pulse width adjusting device has a timing adjustment circuit described in any of claims 28-44.

46. A type of optical disk recorder having a pulse width adjustment device described in claim 45.

47. The optical disk recorder described in claim 46 characterized by the fact that said optical disk recorder is a CD-R, CD-RW, DVD-R, DVD-RW, DVD+R, DVD+RW or DVD-RAM device.

48. A type of synchronization device having a timing adjustment circuit described in any of claims 28-36, 43, and 44.
